(19) United States
(12) Patent Application Publication
(10) Pub. No.: US 2025/0043108 A1
(43) Pub. Date: Feb. 6, 2025

(54) Thermoplastic polymer powder for 3D printing

(71) Applicant: ARKEMA FRANCE, COLOMBES (FR)

(72) Inventor: Jean-Charles DURAND, Colombes (FR)

(73) Assignee: ARKEMA FRANCE, COLOMBES (FR)

(21) Appl. No.: 18/719,895

(22) PCT Filed: Dec. 22, 2022
(86) PCT No.: PCT/FR2022/052481

§ 371 Date: Jun. 14, 2024

(30) Foreign Application Priority Data
Dec. 23, 2021 (FR) FR2114327

(51) Int. Cl. C08K 5/372; B29C 64/357; B33Y 40/00; B33Y 70/10; C08G 69/06; C08G 69/08; C08J 3/12; C08J 3/20; C08K 3/22; C08K 3/36; C08K 5/134; C08K 9/06

(52) U.S. Cl. CPC C08K 5/372; B29C 64/357; B33Y 40/00; B33Y 70/10; C08G 69/06; C08G 69/08; C08J 3/12; C08J 3/203; C08K 3/22; C08K 3/36; C08K 5/134; C08K 9/06; C08J 2377/10; C08K 2003/2227; C08K 2003/2296

(57) ABSTRACT

The present invention relates to a polymer powder for the manufacture of articles by 3D printing, in particular by sintering, comprising a thermoplastic polymer, antioxidants, and a particular metal oxide, metal hydroxide and/or hydrotalcite, having improved thermal stability, improved recyclability and improved consistency of mechanical properties of the sintered parts.

The invention also relates to a process for preparing this powder and to the use thereof in a process for manufacturing by sintering, and to the articles manufactured from said powder.

### FIELD OF THE INVENTION

The present invention relates to a polymer powder for the manufacture of articles by 3D printing, in particular by sintering, comprising a thermoplastic polymer, antioxidants, and a particular compound chosen from a metal oxide, a metal hydroxide and/or a hydrotalcite, having improved thermal stability, improved recyclability and improved consistency of mechanical properties of the sintered parts.

The invention also relates to a process for preparing this powder and to the use thereof in a process for manufacturing by sintering, and to the articles manufactured from said powder.

### TECHNICAL BACKGROUND

There are various 3D printing techniques that use a polymer powder. The principle is generally based on the agglomeration of powders, layer by layer, by melting said layer (hereinafter “sintering”) brought about by electromagnetic radiation, for example, one or more laser beams (laser sintering), infrared radiation, UV radiation, or any source of electromagnetic radiation which makes it possible to melt the powder layer by layer in order to manufacture three-dimensional objects.

Mention may be made of Selective Laser Sintering (SLS) technology. Mention may also be made of sintering technologies using an absorber, for example the technologies known under the names “High Speed Sintering” (HSS) and “Multi-Jet Fusion” (MJF).

For sintering processes such as SLS or MJF, the use of thermoplastic polymer powder, for example a polyamide powder, is favored.

During each build in a sintering process, also known as a run, a large portion of the powder is unused: for example, approximately 85% of the powder is not targeted by the laser in SLS, or else by infrared in MJF, and therefore is non-agglomerated and/or not melted. It is thus advantageous to be able to reuse, i.e. to recycle, this powder during the next build (or next “run”).

However, during the sintering process, the presence of oxygen at high temperature can cause thermo-oxidative degradation of the polymer, inducing undesirable yellowing of the powder, thereby preventing reuse of the non-agglomerated powder. It is also possible to observe a decrease in the inherent viscosity of the powders due to the thermo-oxidative degradation of the powders; the sintered parts obtained may experience a loss of mechanical properties. These thermal oxidation phenomena also take place in inerted machines, where the content of oxygen is certainly reduced, but where it remains present.

There is a continuous need to provide a thermoplastic polymer powder having good thermal stability, for the manufacture of sintered parts which have satisfactory mechanical properties and in order to be recyclable.

For the purposes of the present invention, thermal stability is understood to mean a reduced thermo-oxidative degradation, namely in particular limited yellowing (i.e. a limited increase in YI) and/or a limited decrease in the inherent viscosity of the powder that has not agglomerated during sintering.

It is known to employ antioxidants in a powder formulation in order to improve recyclability of the powder and/or to limit yellowing thereof.

Document FR 3087198 describes a powder intended for 3D printing, based on thermoplastic polymer, comprising a thioether antioxidant.

However, the antioxidant effect of the thioether has not always proven to be satisfactory. Indeed, yellowing of the powder has been observed when the latter is used in a 3D printing machine. Furthermore, an unpleasant sulfur odor can be smelled when said powder is used and even after conversion in a 3D printing machine.

Document US 2004/0138363 describes a powder containing polyamide and titanium oxide particles. It is indicated that this powder has resistance to yellowing when the powder is exposed to thermal stress during 3D printing by laser sintering.

However, the anti-yellowing effect of the titanium oxide has not always proven to be satisfactory.

The aim of the present invention is to provide a solution to one or more of the abovementioned problems.

More particularly, the aim of the invention is to provide a thermoplastic polymer powder, preferably a polyamide powder, comprising antioxidants, and a particular metal oxide, metal hydroxide, and/or hydrotalcite and having improved thermal stability and thus better recyclability.

In the context of the present invention, a powder having improved thermal stability means a powder having a yellowness index (YI), measured after having been exposed under air at 177° C. in a volume of approximately 50 ml for 72 h, that is at least 20% less than the index measured under the same conditions for the same powder without the presence of the particular metal oxide, metal hydroxide, and/or hydrotalcite.

### SUMMARY OF THE INVENTION

According to a first aspect, the present invention relates to a polymer powder suitable for 3D printing by sintering, comprising (a) a semicrystalline thermoplastic polymer, (b) one or more antioxidants and (c) a metal oxide, a metal hydroxide, and/or a hydrotalcite, the metal oxide, the metal hydroxide and the hydrotalcite being derived from one or more alkaline-earth metals, or from one or more post-transition metals, preferably from one or more post-transition metals.

The semicrystalline thermoplastic polymer of use according to the invention may be chosen from: polyolefin, polyamide, polyester, polyaryletherketone, polyphenylene sulfide, polyacetal, polyimide, polyvinylidene fluoride, and/or a mixture thereof, preferably a polyamide.

According to one embodiment, the metal oxide is chosen from ZnO and/or Al₂O₃.

It is preferable for component (c) to be in pulverulent form having a Dv suitable for 3D printing.

According to one embodiment, the one or more antioxidants are chosen from one or more phenolic antioxidants, one or more phosphite/phosphonite antioxidants, one or more thioethers, and/or mixtures thereof.

Thus, the powder of the present invention may comprise a mixture of phenolic and phosphite/phosphonite antioxidants, or of phenolic and thioether antioxidants, or of phosphite/phosphonite and thioether antioxidants, or else of phenolic and phosphite/phosphonite and thioether antioxidants.

Preferably, the one or more antioxidants are chosen from one or more phenolic antioxidants, one or more thioethers and/or mixtures thereof.

According to one embodiment, the polymer powder further comprises fillers or reinforcements (d) and/or one or more additional additives (e).

It has been observed in the context of the present invention that the use of the particular metal oxide, metal hydroxide, and/or hydrotalcite, preferably in combination with one or more antioxidants in a thermoplastic polymer powder suitable for 3D printing by sintering, makes it possible to improve the thermal stability of said powder, while retaining acceptable mechanical properties during successive builds.

More particularly, the addition of the metal oxide, the metal hydroxide and/or the hydrotalcite as defined in the present invention, preferably in combination with one or more antioxidants, in a polymer powder suitable for printing by sintering, makes it possible to very advantageously limit the yellowing of the powder, during successive builds and/or on the printed part.

Furthermore, a decrease in the unpleasant sulfur odor when it is used and even after conversion in a 3D printing machine has been observed.

The present invention thus proposes a powder having excellent recyclability, even when the sintering process is conducted under harsh conditions, typically under air at high temperature (namely generally a few degrees below the melting point) and/or for a prolonged build time and/or when a high volume of parts is built.

Moreover, surprisingly, it has been observed that the addition of the metal oxide, the metal hydroxide, and/or the hydrotalcite as defined in the present invention, preferably in combination with one or more antioxidants, makes it possible to obtain printed parts having improved mechanical properties throughout the production, while avoiding the production of parts with low elongations at break (generally those less than 10%). Indeed, compared with one and the same powder without the addition of the metal oxide, the metal hydroxide and/or the hydrotalcite as defined in the present invention, parts having low elongations are generally observed, which can generate large amounts of parts having properties that are not satisfactory for industrial scale manufacture.

According to one aspect, the invention is targeted at a process for preparing a powder as defined above.

A subject of the present invention is also the use of a metal oxide, a metal hydroxide, and/or a hydrotalcite derived from one or more alkaline-earth metals, or from one or more post-transition metals, preferably from one or more post-transition metals, in a polymer powder suitable for 3D printing by sintering, for improving the thermal stability, in particular for limiting the yellowing, of said powder.

A subject of the present invention is also the use of a metal oxide, a metal hydroxide, and/or a hydrotalcite derived from one or more alkaline-earth metals, or from one or more post-transition metals, preferably from one or more post-transition metals, in a polymer powder suitable for 3D printing by sintering, for improving the mechanical property, in particular the elongation at break, of the printed parts manufactured from said powder.

Preferably, the powder comprises one or more antioxidants, preferably chosen from one or more phenolic antioxidants, one or more phosphite/phosphonite antioxidants, one or more thioethers, and/or mixtures thereof.

Preferably, the metal oxide is chosen from ZnO and/or Al₂O₃.

The present invention also relates to a 3D printing process, preferably a process by sintering brought about by electromagnetic radiation, using the powder as defined above, or a powder comprising a non-agglomerated portion of said powder recovered after one or more builds within the same printing process or a different printing process.

The electromagnetic radiation is preferably chosen from one or more laser beams, infrared radiation or UV radiation, with or without an absorber.

The present invention also relates to an article obtained by the 3D printing process as defined above.

The article may be chosen from prototypes, models and parts, particularly in the automotive, nautical, aeronautical, aerospace, medical (prostheses, hearing systems, cell tissues, etc.), textile, clothing, fashion, decoration, design, electronic housing, telephony, computing, lighting, sport and industrial tool sectors.

Preferably, the inherent viscosity in solution (also referred to as “inherent viscosity”) of the printed part is greater than 0.8, such that the article has acceptable mechanical properties. More preferably, the inherent viscosity of the printed part is greater than 1.0. Generally, the inherent viscosity of the printed part is less than 4.0, preferably less than 3.0.

The invention is now described in detail and in a nonlimiting way in the description which follows.

### DESCRIPTION OF THE INVENTION

### Definition

In the present description of the invention, including in the examples below:

Dv50, also referred to herein as the “volume-median diameter”, corresponds to the value of the particle size which divides the population of particles examined exactly in two. The Dv50 is measured according to the standard ISO 13320-1. In the present description, a Malvern Insitec particle size analyzer with RTSizer software is used to obtain the particle size distribution of the powder and to deduce the Dv50 therefrom.

The inherent viscosity in solution (particularly of the polyamide, of the polyamide powders or of the parts manufactured by sintering from said polyamide or polyamide powders) is measured according to the following steps:
taking samples of polymer of between 0.07 and 0.10 g and preferably of 0.15 g maximum,
adding a sufficient amount of m-cresol solvent by weighing in order to obtain a concentration (C) of 0.5 g/l,
heating the mixture with stirring on a hot plate, regulated at 100° C.±5° C., until the polymer has completely dissolved,
cooling the solution to ambient temperature, preferably for at least 30 minutes,
measuring the flow time to of the pure solvent and the flow time t of the solution using a micro-Ubbelohde tube viscometer in a thermostatically-controlled bath regulated at 20° C.±0.05° C.,
calculating the viscosity according to the formula 1/Cx Ln (t/t0), where C represents the concentration and Ln the natural logarithm.

For each sample, three measurements are taken on different solutions, then the mean is calculated.

The thermal characteristics of the polyamide are analyzed by DSC according to the standard ISO 11357-3 “Plastics-Differential Scanning calorimetry (DSC) Part 3: Determination of temperature and enthalpy of melting and crystallization”. The temperatures that more particularly concern the invention herein are the first-heat melting point (Mp1), the crystallization temperature (Tc) and the enthalpy of fusion.

“Semicrystalline thermoplastic polymer” means a thermoplastic polymer which has:
a crystallization temperature (Tc) determined, according to the standard ISO 11357-3:2013, during the step of cooling at a rate of 20 K/min in DSC (differential scanning calorimetry);
a melting point (Mp) determined, according to the standard ISO 11357-3:2013, during the step of heating at a rate of 20 K/min in DSC; and
an enthalpy of fusion (ΔHf) determined, according to the standard ISO 11357-3:2013, during the step of heating at a rate of 20 K/min in DSC, which is greater than 5 J/g, for example greater than 10 J/g, preferably greater than 20 J/g, and is generally less than 205 J/g, preferably less than 150 J/g.

The yellowing is quantified by the yellowness index (YI) measured according to the standard ASTM E313-96 (D65), particularly using a Konica Minolta spectrocolorimeter with the illuminant D65 at 10° in specular component included (SCI) reflection mode.

The mechanical properties, particularly the tensile modulus and the elongation at break, are measured according to the standard ISO 527-1B: 2012.

In the present description, it is noted that when reference is made to ranges, expressions of the type “between . . . and . . . ” include the limits of the range.

Unless otherwise mentioned, the percentages expressed are percentages by weight. Unless otherwise mentioned, the parameters to which reference is made are measured at atmospheric pressure and at ambient temperature (23° C.).

The nomenclature used to denote the polyamides follows the standard ISO 1874-1:2011. In the present description, the term “monomer” should be taken with the meaning of “repeat unit”. In particular, in the PA “XY” notation denoting a polyamide resulting from the condensation of a diamine with a dicarboxylic acid, X represents the number of carbon atoms of the diamine and Y represents the number of carbon atoms of the dicarboxylic acid. In the PA “Z” notation, Z represents the number of carbon atoms of the polyamide units resulting from the condensation of an amino acid or lactam. The notations PA X/Y, PA X/Y/Z, etc. (referred to in the context of the invention as PA “X/Y”), relate to copolyamides wherein X, Y, Z, etc., represent homopolyamide units X, Y, Z as described in the present invention.

### Semicrystalline Thermoplastic Polymer

The semicrystalline thermoplastic polymer of the present invention has an enthalpy of fusion (ΔHf) determined, according to the standard ISO 11357-3:2013 during the heating step at a rate of 20 K/min in DSC, which is greater than 5 J/g.

The semicrystalline thermoplastic polymer of use according to the invention may be chosen from: polyolefin, polyamide, polyester, polyaryletherketone, polyphenylene sulfide, polyacetal, polyimide, polyvinylidene fluoride, and/or a mixture thereof, preferably a polyamide.

Preferably, the semicrystalline thermoplastic polymer is a polyamide.

The polyamide can be a homopolyamide (i.e. PA “XY” and PA “Z”), a copolyamide (i.e. PA “X/Y”), or mixtures thereof.

“Z”-type polyamides result from the condensation of one or more α,ω-aminocarboxylic acids and/or of one or more lactams.

Mention may be made, by way of example of α,ω-aminocarboxylic acid, of α,ω-amino acids, such as aminocaproic acid, 7-aminoheptanoic acid, 11-aminoundecanoic acid, n-heptyl-11-aminoundecanoic acid and 12-aminododecanoic acid.

Mention may be made, by way of example of lactams, of those having from 3 to 12 carbon atoms on the main ring and which may be substituted. Mention may be made, for example, of β,β-dimethylpropiolactam, α,α-dimethylpropiolactam, amylolactam, caprolactam, capryllactam, enantholactam, 2-pyrrolidone and lauryllactam.

By way of example of this type of preferred polyamides, mention may be made of PA 6, PA 11 and PA 12.

“XY”-type polyamides originate from the condensation of a dicarboxylic acid with an aliphatic, cycloaliphatic or aromatic diamine.

Mention may be made, by way of example of diamine, of aliphatic diamines having from 6 to 12 atoms, it also being possible for the diamine X to be aryl and/or saturated cyclic. By way of examples, mention may be made of hexamethylenediamine, piperazine, tetramethylenediamine, octamethylenediamine, decamethylenediamine, dodecamethylenediamine, 1,5-diaminohexane, 2,2,4-trimethyl-1,6-diaminohexane, polyol diamines, isophoronediamine (IPD), methylpentamethylenediamine (MPDM), bis(aminocyclohexyl) methane (BACM), bis(3-methyl-4-aminocyclohexyl) methane (BMACM), meta-xylylenediamine, trimethylhexamethylenediamine.

By way of examples of dicarboxylic acid, mention may be made of acids having between 4 and 18 carbon atoms, preferably from 9 to 12 carbon atoms. Mention may be made, for example, of adipic acid, sebacic acid, azelaic acid, suberic acid, isophthalic acid, butanedioic acid, 1,4-cyclohexanedicarboxylic acid, terephthalic acid, the sodium or lithium salt of sulfoisophthalic acid, dimerized fatty acids (in particular those having a dimer content of at least 98% and/or that are hydrogenated) and 1,2-dodecanedioic acid HOOC—(CH2) 10-COOH.

Examples of this type of preferred polyamides are PA 612, resulting from the condensation of hexamethylenediamine and of 1,12-dodecanedioic acid; PA 613, resulting from the condensation of hexamethylenediamine and of brassylic acid; PA 912, resulting from the condensation of 1,9-nonanediamine and of 1,12-dodecanedioic acid; PA 1010, resulting from the condensation of 1,10-decanediamine and sebacic acid; PA 1012, resulting from the condensation of 1,10-decanediamine and of 1,12-dodecanedioic acid.

The polyamide can also be a copolyamide resulting from the condensation:
of at least two different monomers, for example of at least two different α,ω-aminocarboxylic acids, or
of two different lactams, or
of a lactam and of an α,ω-aminocarboxylic acid having different carbon numbers, or
of at least one α,ω-aminocarboxylic acid (or a lactam), at least one diamine and at least one dicarboxylic acid, or
of an aliphatic diamine with an aliphatic dicarboxylic acid and at least one other monomer chosen from aliphatic diamines other than the preceding one and aliphatic diacids other than the preceding one.

Use may also be made of mixtures of polyamides, which may be mixtures of aliphatic polyamides and of semiaromatic polyamides and mixtures of aliphatic polyamides and of cycloaliphatic polyamides.

The polyamide of the present invention can also be a copolymer having polyamide blocks and polyether blocks (PEBA) or a mixture of a copolymer having polyamide blocks and polyether blocks with at least one of the abovementioned polyamides.

PEBA copolymers can result from the copolycondensation of polyamide blocks having reactive ends with polyether blocks having reactive ends, such as, inter alia:
1) polyamide blocks having diamine chain ends with polyoxyalkylene blocks having dicarboxylic chain ends;
2) polyamide blocks having dicarboxylic chain ends with polyoxyalkylene blocks having diamine chain ends;
3) polyamide blocks having dicarboxylic chain ends with polyetherdiols, the products obtained being, in this specific case, polyetheresteramides.

The polyamide blocks can be a homopolyamide or a copolyamide as described above for homopolyamides and copolyamides.

The polyamide blocks having dicarboxylic chain ends originate, for example, from the condensation of polyamide precursors in the presence of a dicarboxylic acid-type chain limiter. The polyamide blocks having diamine chain ends originate, for example, from the condensation of polyamide precursors in the presence of a diamine-type chain limiter.

The polyether blocks of the PEBA can result from alkylene glycols, such as PEG (polyethylene glycol), PPG (polypropylene glycol), PO3G (polytrimethylene glycol) or PTMG (polytetramethylene glycol), preferably PTMG.

The polymers having polyamide blocks and polyether blocks can comprise randomly distributed units. These polymers can be prepared by the simultaneous reaction of the polyether and of the precursors of the polyamide blocks.

The polyether diol blocks are either used in unmodified form and copolycondensed with polyamide blocks having carboxylic end groups, or they are aminated to be converted into polyetherdiamines and condensed with polyamide blocks having carboxylic end groups. They can also be mixed with polyamide precursors and a chain limiter in order to make polymers having polyamide blocks and polyether blocks which have randomly distributed units.

The ratio of the amount of copolymer having polyamide blocks and polyether blocks to the amount of polyamide is advantageously between 1/99 and 15/85 by weight.

As regards the mixture of polyamide and of at least one other polymer, it is provided in the form of a mixture having a polyamide matrix and the other polymer(s) form(s) the dispersed phase. Mention may be made, as examples of this other polymer, of polyolefins, polyesters, polycarbonate, PPO (abbreviation for polyphenylene oxide), PPS (abbreviation for polyphenylene sulfide) or elastomers.

Preferably, the powders comprise at least one polyamide chosen from polyamides, copolyamides and/or PEBA copolymers comprising at least one of the following XY or Z monomers: 46, 4T, 54, 59, 510, 512, 513, 514, 516, 518, 536, 6, 64, 66, 69, 610, 612, 613, 614, 616, 618, 636, 6T, 9, 104, 109, 1010, 1012, 1013, 1014, 1016, 1018, 1036, 10T, 11, 12, 124, 129, 1210, 1212, 1213, 1214, 1216, 1218, 1236, 12T, MXD6, MXD10, MXD12, MXD14, and mixtures thereof; in particular chosen from PA 6, PA 11, PA 12, PA 612, PA 613, PA 912, PA 1010, PA1012 6, PA 6/12, PA 11/1010, and mixtures thereof.

The powder of the invention typically comprises from 36% to 99.9%, preferably from 40% to 95%, by weight of a thermoplastic polymer, relative to the total weight of the powder.

### Antioxidants

The composition (b) according to the invention is chosen from one or more phenolic antioxidants, one or more phosphite/phosphonite antioxidants, one or more thioethers, and/or mixtures thereof.

The powder of the invention typically comprises from 0.1% to 2%, preferably from 0.5% to 1%, by weight of one or antioxidants, relative to the total weight of the powder.

### Phenolic Antioxidant

According to one embodiment, the powder of the invention comprises a phenolic antioxidant, such as:
3,3′-bis(3,5-di-tert-butyl-4-hydroxyphenyl)-N,N′-hexamethylenedipropionamide sold in particular under the name Palmarole AO.OH.98 by Palmarole,
(4,4′-butylidenebis(2-t-butyl-5-methylphenol) sold in particular under the name Lowinox® 44B25 by Addivant,
pentaerythritol tetrakis(3-(3,5-di-tert-butyl-4-hydroxyphenyl) propionate) sold in particular under the name Irganox® 1010 by BASF,
N,N′-hexane-1,6-diylbis(3-(3,5-di-tert-butyl-4-hydroxyphenylpropionamide)) sold in particular under the name Irganox® 1098 by BASF,
3,3′,3′,5,5′,5′-hexa-tert-butyl-a,a′,a′-(mesitylene-2,4,6-triyl) tri-p-cresol sold in particular under the name Irganox® 1330 by BASF,
ethylenebis(oxyethylene)bis(3-(5-tert-butyl-4-hydroxy-m-tolyl) propionate) sold in particular under the name Irganox® 245 by BASF,
1,3,5-tris(3,5-di-tert-butyl-4-hydroxybenzyl)-1,3,5-triazine-2,4,6 (1H,3H,5H)trione sold in particular under the name Irganox® 3114 by BASF,
N′,N′-(2-ethyl-2′-ethoxyphenyl) oxanilide sold in particular under the name Tinuvin® 312 by BASF,
4,41,4″-[trimethyl-1,3,5-benzenetriyl)tris(methylene)]tris-2,6-bis(1,1-dimethylethyl) phenol sold in particular under the name Alvinox® 1330 by 3V, Hostanox® 245 FF, Hostanox® 245 Pwd, sold by Clariant,
pentaerythrityl tetrakis(3-(3,5-di-tert-butyl-4-hydroxyphenyl) propionate) sold in particular under the names Evernox® 10 and Evernox® 10GF by Everspring Chemical Company Limited,
octadecyl 3-(3,5-di-tert-4-hydroxyphenyl) propionate sold in particular under the names Evernox® 76 and Evernox® 76GF by Everspring Chemical Company Limited,
tetrakis [methylene-3-(31,5′-di-tert-butyl-4-hydroxyphenyl) propionate]methane sold in particular under the name BNX® 1010 by Mayzo,
thiodiethylene bis [3-(3,5-di-tert-butyl-4-hydroxyphenyl) propionate] sold in particular under the name BNX® 1035 by Mayzo,
octadecyl 3-(3,5-di-tert-butyl-4-hydroxyphenyl) propionate sold in particular under the name BNX® 2086 by Mayzo, and
1,3,5-tris(3,5-di-tert-butyl-4-hydroxybenzyl)-1,3,5-triazine-2,4,6 (1H,3H,5H)trione sold in particular under the name BNX® 3114 by Mayzo.

### Phosphite/Phosphonite Antioxidant

According to one embodiment, the powder comprises phosphite/phosphonite antioxidants comprising aromatic or aliphatic phosphonites, such as the product Hostanox® P-EPQ® sold by Clariant, alkali metal salts of phenylphosphonic acid or of hypophosphorous acid, compounds comprising phosphite functions, such as trialkyl and trialkylaryl phosphites, and cyclic diphosphites derived from pentaerythritol, for example Irgafos® 168 sold by BASF.

As examples of trialkyl and trialkylaryl phosphites, mention may be made of trinonyl, tri (nonylphenyl) and tri [(2,4-di-tert-butyl-5-methyl)phenyl] phosphites. As examples of cyclic diphosphites derived from pentaerythritol, mention may be made of distearyl pentaerythritol diphosphite.

### Thioether

According to one embodiment, the thioether is chosen from: dilauryl thiodipropionate (DLTDP), ditridecyl thiodipropionate (DTDTDP), distearyl thiodipropionate (DSTDP), dimyrystyl thiodipropionate (DMTDP), pentaerythritol tetrakis(3-dodecylthiopropionate) or pentaerythritol tetrakis(3-laurylthiopropionate), alkyl(C12-C14)thiopropionate, dilauryl 3,3′-thiodipropionate, ditridecyl 3,3′-thiodipropionate, dimyristyl 3,3′-thiodipropionate, distearyl 3,3′-thiodipropionate, dioctadecyl 3,3′-thiodipropionate, lauryl stearyl 3,3-thiodipropionate, tetrakis [methylene-3-(dodecylthio) propionate]methane, thiobis(2-tert-butyl-5-methyl-4,1-phenylene)bis(3-(dodecylthio) propionate), 2.2′-thiodiethylene bis(3-aminobutenoate), 4,6-bis(octylthiomethyl)-o-cresol, 2,2′-thiodiethylene bis [3-(3,5-tert-butyl-4-hydroxyphenyl) propionate], 2,2′-thiobis((4-methyl 6-tert-butylphenol), 2,2′-thiobis(6-tert-butyl-p-cresol), 4,4′-thiobis(6-tert-butyl-3-methylphenol), 4,4′-thiobis(4-methyl 6-tert-butylphenol), bis(4,6-tert-butyl-I-yl-2-) sulfide, tridecyl-3,5-di-tert-butyl-4-hydroxybenzyl thioacétate, 1,4-bis(octylthiomethyl)-6-phenol, 2,4-bis(dodecylthiomethyl)-6-methylphenol, distearyl disulfide, bis(methyl-4-[3-n-alkyl(C12/C14)thiopropionyloxy]-5-tert-butylphenyl) sulfide and/or mixtures thereof.

Preferably, the thioether is chosen from the group consisting of dilauryl thiodipropionate (DLTDP), ditridecyl thiodipropionate (DTDTDP), distearyl thiodipropionate (DSTDP), dimyristyl thiodipropionate (DMTDP), pentaerythrityl tetrakis(3-dodecylthiopropionate) or pentaerythrityl tetrakis(3-laurylthiopropionate), and/or mixtures thereof.

According to one embodiment, the thioether is DLTDP.

According to one embodiment, the thioether is DSTDP.

Even more preferably, the thioether is pentaerythrityl tetrakis(3-dodecylthiopropionate). Such a compound is sold particularly by Songnox, or Adeka under the trade name ADK STAB AO-412S.

Preferably, the thioether has a melting point of less than or equal to 180° C., preferably less than or equal to 160° C., preferentially less than or equal to 140° C., even more preferentially less than or equal to 130° C., or to 100° C.

### Metal Oxide/Metal Hydroxide/Hydrotalcite

Component (c) of the present invention is chosen from a metal oxide, a metal hydroxide, and/or a hydrotalcite derived from one or more alkaline-earth metals, or from one or more post-transition metals, preferably from one or more post-transition metals.

According to one embodiment, component (c) is a hydrotalcite derived from one or more alkaline-earth metals, or from one or more post-transition metals, preferably from one or more post-transition metals.

The hydrotalcite according to the invention may typically be according to formula Mₐ²⁺M_{b}³⁺ (OH)_{2a+2b}⁻(Xⁱ⁻)_{b/i}, yH₂O wherein Mₐ²⁺ represents divalent metal ions, M_{b}³⁺ represents trivalent metal ions, and Xⁱ⁻ represents an anion, typically a carbonate or a nitrate.

For example, a hydrotalcite usable in the powder of the invention may be Mg₆Al₂CO₃(OH)₁₆·4(H₂O).

According to one embodiment, component (c) is derived from one or more alkaline-earth metals, i.e. metals of the second group of the periodic table.

Preferably, the alkaline-earth metals are chosen from magnesium, calcium, strontium and/or barium.

According to one embodiment, component (c) is derived from one or more post-transition metals.

The term “post-transition metals” is understood to mean a metallic chemical element located, in the periodic table, between the transition metals on their left and the metalloids on their right.

Preferably, the post-transition metals are chosen from aluminum, gallium, indium, zinc and/or tin, preferably chosen from zinc and/or aluminum.

Preferably, component (c) is chosen from ZnO and/or Al₂O₃.

The powder of the invention generally comprises from 0.05% to 2%, preferably from 0.1% to 1% by weight of component (c), relative to the total weight of the powder.

### Polymer Powder

According to one embodiment, the polymer powder according to the invention comprises a thermoplastic polymer (a), a thioether (b), a metal oxide, a metal hydroxide, and/or a hydrotalcite derived from one or more alkaline-earth metals, or from one or more post-transition metals, preferably from one or more post-transition metals (c), fillers or reinforcements (d) and/or one or more additional additives (e).

According to one embodiment, the powder according to the invention comprises:
(a) 36% to 99.9%, preferably 40% to 95%, by weight of a thermoplastic polymer;
(b) 0.1% to 2%, preferably 0.5% to 1%, by weight of one or more antioxidants;
(c) 0.0% to 2%, preferably 0.1% to 1%, by weight of a metal oxide, a metal hydroxide, and/or a hydrotalcite;
(d) 0% to 50%, preferably 10% to 50%, and in particular 20% to 40%, by weight of fillers or reinforcements; and
(e) 0% to 30%, preferably 0% to 10%, preferentially 0.1% to 7.5%, in particular 1% to 5%, by weight of additional additives, the respective proportions of the components (a), (b), (c), (d) and (e) adding up to 100%.

The component (e) can comprise one or more of these additives.

Preferably, the polymer powder has a first-heat melting point (Mp1) of between 80° C. and 220° C., preferably of between 100° C. and 200° C.

The powder can have a crystallization temperature (Tc) of from 40° C. to 250° C., and preferably from 45° C. to 200° C., for example from 60° C. to 170° C.

When a mixture of polymers (a) is concerned, the lowest Mp in the mixture is regarded as the Mp and the highest Tc in the mixture is regarded as the Tc.

The difference between the Tc and the Mp of the powder is preferably greater than or equal to 20° C., or more preferably greater than or equal to 30° C.

According to one embodiment, the inherent viscosity in solution of the powder, before use thereof in a sintering process, is typically less than 3, preferably less than 2.

Preferably, the inherent viscosity of the powder not affected by the electromagnetic radiation after a first build in a sintering process is between 0.8 and 3, preferably between 1 and 2.

Typically, the polymer powder according to the invention has a Dv50 diameter of 40 to 150 μm and preferably of 40 to 100 μm. For example, the Dv50 diameter of the polymer powder can be from 40 to 45 μm; or from 45 to 50 μm; or from 50 to 55 μm; or from 55 to 60 μm; or from 60 to 65 μm; or from 65 to 70 μm; or from 70 to 75 μm; or from 75 to 80 μm; or from 80 to 85 μm; or from 85 to 90 μm; or from 90 to 95 μm; or from 95 to 100 μm; or from 100 to 105 μm; or from 105 to 110 μm; or from 110 to 115 μm; or from 115 to 120 μm; or from 120 to 125 μm; or from 125 to 130 μm; or from 130 to 135 μm; or from 135 to 140 μm; or from 140 to 145 μm; or from 145 to 150 μm.

### Fillers and Reinforcements

The polymer powder according to the invention can moreover optionally comprise fillers or reinforcements, in particular in order to ensure that the printed article has satisfactory mechanical properties, in particular in terms of modulus. These fillers can in particular be carbonate minerals, in particular calcium carbonate, magnesium carbonate, dolomite rock, calcite, barium sulfate, calcium sulfate, dolomite mineral, alumina hydrate, wollastonite, montmorillonite, zeolite, perlite or nanofillers (fillers having a dimension of the order of a nanometer), such as nanoclays, calcium silicates, magnesium silicates, such as talcum, mica, kaolin, attapulgite, and mixtures thereof. Mention may particularly be made, as reinforcements, of carbon nanotubes, glass powder, glass fibers and carbon fibers, and also solid or hollow glass beads optionally coated with silane. The component (d) can comprise one or more fillers and/or reinforcements. Advantageously, the fillers and reinforcements do not comprise pigments as defined above for the pigment composition.

More specifically, the powder of the invention can comprise 0% to 50% or from 5% to 50% or from 10% to 40% or from 10% to 30% by weight of component (d). According to one embodiment, the polymer powder is devoid of fillers and reinforcements.

### Additional Additives

The polymer powder can comprise, where appropriate, additional additives (e) that are customary in polymer powders used in 3D printing by sintering.

The powder of the invention may comprise from 0% to 30% of additional additive.

These can in particular be additives, whether in powder form or not, which contribute to improving the behavior of the powder in 3D printing by sintering and those which make it possible to improve the properties of the printed articles, in particular the mechanical strength, thermal resistance, fire resistance, and in particular the elongation at break and the impact strength.

These customary additives may in particular be chosen from flow agents, chain limiters, flame retardants (fireproofing agents), UV stabilizers, anti-abrasion agents, light stabilizers, impact modifiers, antistatic agents, pigments and waxes.

### Flow Agent

By way of examples, the flow agent may for example be chosen from silicas, particularly hydrophobic fumed silica; mention may for example be made of the product sold under the name Cab-o-Sil® TS610 by Cabot Corporation, precipitated silica, hydrated silica, vitreous silica, pyrogenic silica, vitreous oxides, particularly vitreous phosphates, vitreous borates, alumina, such as amorphous alumina, and mixtures thereof.

### Flame Retardants (Fireproofing Agents)

By way of examples, the fire retardants may be chosen from a halogen-based retardant, a phosphorus-based retardant, an inorganic hydrated metal compound retardant, a nitrogen-containing retardant and a silicone-based retardant.

According to one embodiment, the powder of the invention comprises from 10% to 30% by weight of the flame retardant, preferably from 10% to 25% by weight, relative to the total mass of the powder.

According to one embodiment, the flame retardant is of cyclic phosphonate ester type and is of general formula (I):

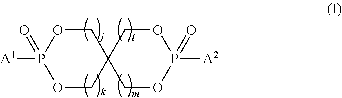

wherein:
j, k, l and m, which may be identical or different, represent an integer from 1 to 3;
A¹ and A², which may be identical or different, represent an alkyl group of 1 to 4 carbon atoms or an aryl group of 5 to 7 carbon atoms.

More preferably, the flame retardant of cyclic phosphonate ester type is of general formula (II):

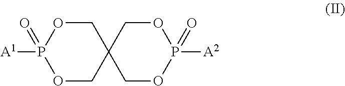

wherein A¹ and A², which may be identical or different, represent an alkyl group of 1 to 4 carbon atoms or an aryl group of 5 to 7 carbon atoms.

Even more preferably, the flame retardant of cyclic phosphonate ester type is of following formula (III):

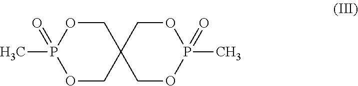

Generally, the flame retardant is a powder, which typically has a volume-median diameter D50 within the range from 1 to 40 μm, preferably from 5 to 30 μm.

### Pigments

The pigment may be, for example for HSS or MJF technology, a pigment having an absorbance of light with a wavelength of 1000 nm, as measured according to ASTM standard E1790, of less than 40%.

### Wax

The wax may comprise a wax of polyethylene and polypropylene, of polytetrafluoroethylene, of ketones, of acid, of partially esterified acid, of acid anhydride, of ester, of aldehydes, of amides, derivatives thereof and mixtures thereof. The wax may particularly comprise a product sold under the name Crayvallac® WN1135, WN 1495 or WN1265 by Arkema or a product sold under the name Ceridust® 9615A or 8020 sold by Clariant.

According to one embodiment, the wax is present in the powder in the form of a coating at least partially covering the polymer powders.

### Chain Limiter

The powder of the invention can comprise a chain limited chosen from dicarboxylic acids, monocarboxylic acids, diamines and monoamines, each of which may be linear or cyclic.

Preferably, the chain limiter has a melting point of less than 180° C.

The monocarboxylic acid preferably has from 2 to 20 carbon atoms. As examples of monocarboxylic acid, mention may be made of acetic acid, propionic acid, benzoic acid and stearic acid, lauric acid, butanoic acid, pentanoic acid, hexanoic acid, heptanoic acid, octanoic acid, nonanoic acid, decanoic acid, undecanoic acid, acrylic acid, methacrylic acid, crotonic acid, cinnamic acid, hexadecanoic acid, octodecanoic acid and tetradecanoic acid, preferably stearic acid.

The dicarboxylic acid preferably has from 2 to 20 carbon atoms, more preferably from 6 to 10 carbon atoms. As examples of dicarboxylic acid, mention may be made of sebacic acid, adipic acid, azelaic acid, suberic acid, dodecanedicarboxylic acid, butanedioic acid and ortho-phthalic acid, preferably sebacic acid.

The monoamine may particularly be a primary amine having from 2 to 18 carbon atoms. As examples of monoamine, mention may be made of 1-aminopentane, 1-aminohexane, 1-aminoheptane, 1-aminooctane, 1-aminononane, 1-aminodecane, 1-aminoundecane, 1-aminododecane, benzylamine and oleylamine.

The diamine may in particular be a primary diamine comprising from 4 to 20 carbon atoms.

As examples of diamine, mention may be made of the isomers of bis(4-aminocyclohexyl) methane (BACM), bis(3-methyl-4-aminocyclohexyl) methane (BMACM) and 2,2-bis(3-methyl-4-aminocyclohexyl) propane (BMACP), and para-aminodicyclohexylmethane (PACM), isophoronediamine (IPDA), 2,6-bis(aminomethyl) norbornane (BAMN) and piperazine.

The chain limiter may be in powder or liquid form at ambient temperature.

The chain limiter according to the invention is preferably added to the medium comprising the polyamide already formed and is not incorporated in the composition of the polyamide.

Preferably, the chain limiter is incorporated into the polyamide powder by any suitable method known to those skilled in the art, such as for example dry blending, liquid blending, aqueous dispersion, blending by compounding, diffusion blending.

According to one embodiment, the chain limiter, preferably in powder form, is dry blended with a polyamide powder.

According to one embodiment, the chain limiter represents from 0.01% to 10%, preferably from 0.01% to 5%, preferably from 0.01% to 4%, preferably from 0.01% to 3%, preferably from 0.01% to 2%, preferably from 0.01% to 1% by weight relative to the total weight of the thermoplastic polymer or relative to the total weight of the polyamide when the thermoplastic polymer is a polyamide.

The chain limiter may represent from 0.01% to 2% by weight relative to the total weight of the thermoplastic polymer or relative to the total weight of the polyamide when the thermoplastic polymer is a polyamide.

Preferably, the chain limiter represents from 0.01% to 0.5%, from 0.01% to 0.4%, from 0.1% to 0.4%, from 0.1% to 0.3% by weight relative to the total weight of the thermoplastic polymer or relative to the total weight of the polyamide when the thermoplastic polymer is a polyamide.

According to one embodiment, the powder of the invention comprises at least one or more additional additives (e) chosen from a flame retardant and/or a chain limiter.

### Process for Preparing the Polymer Powder

The polymer powder can be manufactured according to the usual processes.

For component (a), use may be made of commercially available thermoplastic polymers, in particular in the form of granules, flakes or powder, or synthetic thermoplastic polymers.

If necessary, the component (a) can be converted into powder, by means of known processes, in particular by grinding.

The grinding may be grinding at ambient temperature.

The grinding may be cryogenic grinding. In this process, the material to be ground is cooled, for example by means of liquid nitrogen, liquid carbon dioxide or liquid helium, in order to make the material easier to grind.

The grinding may be carried out, for example, in a pin mill, a hammer mill or a whirl mill.

According to one embodiment, the process for preparing a powder according to the invention comprises one or more of the following steps:
(i) synthesizing a thermoplastic polymer (a),
(ii) grinding the thermoplastic polymer (a) into a powder with a diameter Dv50 of 40 to 150 μm,
(iii) introducing one or more antioxidants (b), and a metal oxide, a metal hydroxide and/or a hydrotalcite (c), and, where appropriate, one or more components (d) to (e), before or after step (ii).

The introduction of some or all of the components (b) to (e) to the thermoplastic polymer (component (a)) can be carried out according to methods known to those skilled in the art.

By way of example, the introduction may be carried out by melt blending, for example by extrusion (compounding) and, where appropriate, granulation followed by grinding of the granules. The introduction can be carried out by wet impregnation (reference may be made, for example, to the method described in EP 3 325 535 B1). Alternatively, it is also possible to carry out the introduction by dry blending.

According to one embodiment, the introduction step can be carried out during the synthesis of the thermoplastic polymer.

For example, it is possible to blend the components by means of coprecipitation of the polymer (a) from a solution in the presence of some or all of the components (b) to (e) (dissolution/precipitation). The conditions can be readily adapted by those skilled in the art. Reference may for example be made to document EP 0863174 B1.

It is also possible to blend some or all of the components (b) to (e) with a prepolymer of component (a), during or after the synthesis of the prepolymer.

Thus, according to one embodiment, the process for preparing a powder of the invention comprises the steps of:
(i) prepolymerizing the monomer(s) of the thermoplastic polymer (a);
(ii) grinding into a powder;
(iii) subjecting the resulting prepolymer powder to solid-phase polycondensation to obtain a polymer powder;
(iv) introducing one or more antioxidants (b), a metal oxide, a metal hydroxide and/or a hydrotalcite (c), and where appropriate one or more components (d) to (e), to the prepolymer powder by melt blending or dry blending, between steps (i) and (ii), and/or (ii) and (iii), and/or subsequently by dry blending.

It is also possible to use several of these processes, according to the additives, for their introduction into the polymer powder.

The powder thus obtained can subsequently be sieved or subjected to a selection step in order to obtain the desired particle size profile.

According to a certain method of preparation, the polymer powder may, where appropriate, be subjected to different treatments, in particular thermal or hydraulic treatments.

The components can be used in any suitable form according to the preparation method.

According to one embodiment, one or more components are used in powder form. The shape and the size of the particles forming the powder is not particularly limited except by the application of 3D printing by sintering. The particles commonly have a spherical shape. However, their use in other shapes, such as in the form of rods or in lamellar form, is not excluded.

When the components are added to the polymer by dry blending, they advantageously have a volume-median diameter Dv50 substantially less than or equal to that of the powder with which it will be blended. More specifically, the volume-median diameter Dv50 of the components is preferably between 0.01 and 50 μm, preferably between 0.05 and 30 μm, more preferably between 0.1 and 20 μm, in particular between 0.2 and 10 μm and most particularly between 0.5 and 5 μm.

The invention will be further explained in a non-limiting manner with the aid of the examples which follow.

### EXAMPLES

The examples below illustrate the present invention without limiting the scope thereof. In the examples, unless otherwise indicated, all the percentages and parts are expressed by weight.

Although the tests refer to a powder based on polyamide 11, it is understood that the powders according to the present invention are not limited to this embodiment but can comprise any type of polymer, in particular polyamide, alone or as a blend.

The basic powder used is a powder comprising per hundred parts by weight of polyamide 11 the various components as described above.

A low-viscosity polyamide 11, referred to hereinafter as “prepolymer”, was synthesized from 11-aminoundecanoic acid in the presence of water, hypophosphorous acid and phosphoric acid.

The polyamide 11 powder was then prepared by grinding this prepolymer, then subjecting said prepolymer to a hydraulic treatment according to the process described in EP 1413595A, followed by solid-phase polycondensation. Antioxidants were added during the solid-phase polycondensation.

The polyamide 11 powder has an inherent viscosity equal to 1.20 (20° C., in solution at 0.5% by weight in meta-cresol).

The metal oxides and the flow agent were added to the powder by dry blending in a Henschel IAM 6L mixer wherein the compounds to be mixed are introduced in the proportions indicated in table 1 below, and the mixture is stirred at 900 rpm for 100 s at ambient temperature.

The Dv50 of the powder measured is 50 μm.

TABLE 1

| | PA | Phenolic | Flow | Thioether | | Metal oxide | | |
|---|---|---|---|---|---|---|---|---|
| | (100% by | antioxidant | agent | (PHR) | | (PHR) | | |
| Ex. | weight) | (PHR) | (PHR) | PTDP | DSTDP | ZnO | Al₂O₃ | TiO₂ |
| 1 | 100 | 0.4 | 0.13 | 0.5 | — | — | — | — |
| (comparative) | | | | | | | | |
| 2 | 100 | 0.4 | 0.13 | — | 0.5 | — | — | — |
| (comparative) | | | | | | | | |
| 3 | 100 | 0.4 | 0.13 | 0.5 | — | 0.15 | — | — |
| 4 | 100 | 0.4 | 0.13 | 0.5 | — | — | 0.15 | — |
| 5 | 100 | 0.4 | 0.13 | — | 0.5 | 0.13 | — | — |
| 6 | 100 | 0.4 | 0.13 | — | 0.5 | — | 0.13 | — |
| 7 | 100 | 0.4 | 0.13 | 0.5 | — | — | — | 0.15 |
| (comparative) | | | | | | | | |

PHR=parts per hundred of resin (unit of measurement used in formulation denoting the number of parts of a constituent per hundred parts of basic powder by weight).
PTDP is pentaerythrityl tetrakis(3-dodecylthiopropionate).
DSTDP is distearyl thiodipropionate.
Flow agent: hydrophobic fumed silica
   Aging test and measurement of the yellowness index (YI) of the powder

### a) In the Solid State

The test consists in exposing the powder of the examples at 177° C. in a glass bottle placed in an air-ventilated oven for 72 h. The results have been shown in table 3

This test simulates the exposure conditions to which a powder might be subjected in a 3D machine. The measurements of the yellowness index (YI) are taken on a Konica Minolta spectrocolorimeter with the illuminant D65 at 10° in specular component included (SCI) reflection mode, according to the standard ASTM YI (E313-96) (D65).

### b) In the Melt State

The test consists in exposing the powder of the examples at 220° C. in an aluminum dish placed in an air-ventilated oven for 2 h.

The molten film is subsequently detached and the measurement is performed by placing it in front of a Leneta form 2A opacity chart. The results have been shown in table 3 This test simulates the exposure conditions to which a part might be subjected in a 3D printer as the part is being built.

The measurements of the yellowness index (YI) are taken on a Konica Minolta spectrocolorimeter with the illuminant D65 at 10° in SCI mode according to the standard ASTM YI (E313-96) (D65).

TABLE 2

| | | YI (72 h 177° | YI (2 h at 220° |
|---|---|---|---|
| | YI t0 | C. under air) | C. under air) |
| | ASTM YI | ASTM YI | ASTM YI |
| | (E313-96) | (E313-96) | (E313-96) |
| | (D65) in | (D65) in | (D65) in |
| | SCI (solid | SCI (solid | SCI (melt |
| Ex. | state test) | state test) | state test) |
| 1 (comparative) | 2 | 25 | 69 |
| 2 (comparative) | 2 | 29 | 86 |
| 3 | 2 | 14 | 42 |
| 4 | 2 | 18 | 51 |
| 5 | 2 | 20 | 55 |
| 6 | 2 | 22 | 59 |
| 7 (comparative) | 2 | 33 | 74 |

During solid and melt aging tests, it was observed that the yellowness index values are lower for a powder comprising a thioether and a metal oxide (ex. 3 to 6) compared to a powder without the thioether and the metal oxide (ex. 1 and 2) and compared to a powder where the metal oxide is TiO₂. Thus, the use of the thioether and the metal oxide ZnO and/or Al₂O₃ in a polyamide powder made it possible to improve the color stability of the powder and the color stability of the printed part.

### Elongation-at-Break Test

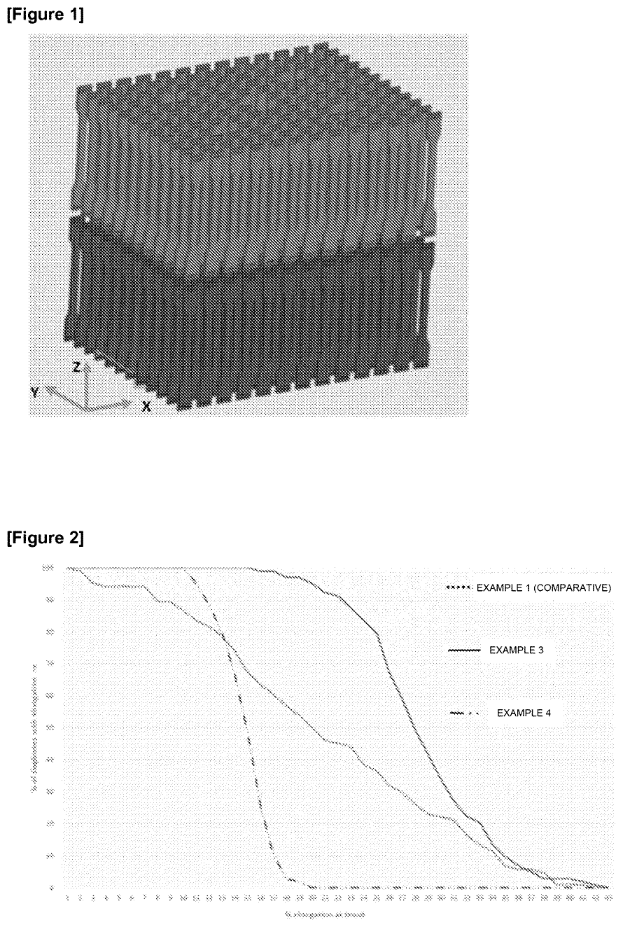

The polymer powder thus obtained is then used to print test specimens of ISO 527-1A geometry. These test specimens are built along the Z axis (vertical axis, FIG. 1) in an MJF5200 machine sold and configured by HP. The conditions used are the same for all the printings.

The model below was prepared using the Materialize Magics 22.0 software.

The test specimens were then built according to this model shown in FIG. 1.

During the build, the temperature of the powder at the surface of the build tank is set, and measured at the surface by means of an infrared heat sensor.

The build time of the two blocks of test specimens is approximately 12 h and they are left to cool to ambient temperature for 48 h.

The lower block test specimens were built first. They were therefore subjected to the thermal oxidation for a longer time.

The lower block test specimens thus obtained are subsequently characterized in terms of their mechanical properties. More specifically, the elongation at break of the test specimens is measured on an Instrom 5966 machine according to the standard ISO 527-2.

[FIG. 2] shows the percentage of test specimens having an elongation greater than x %, x being the abscissa of the graph.

Compared to one and the same powder without the addition of a metal oxide (powder of comparative example 1), it is observed that the proportion of test specimens having an elongation <10% is higher.

It is also observed that the addition of Al₂O₃ (example 4) or ZnO (example 3) reduces the percentage of “brittle” test specimens (0% of test specimens having an elongation <12%), thus reducing the variability of the mechanical properties of the sintered parts. It is thus possible to provide a powder which makes it possible to obtain printed parts with improved mechanical properties, while avoiding the production of parts with low elongation, namely <10%.

Tests were carried out on powders containing a flame retardant.

Example 8 (comparative) is a dry blend (using a Henschel mixer) of 83% by weight of the powder according to example 1 and 17% by weight of the flame retardant of cyclic phosphonate ester type of the formula below:

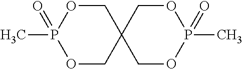

sold under the name Aflammit® PCO 910. The percentage by weight is relative to the total weight of the blend.

Example 9 is a dry blend of the powder of example 8 with ZnO which is added at 0.25% by weight relative to the total weight of the powder of example 8.

The melt aging tests were carried out under the conditions described above. The only difference is that the tests were performed for 1 h.

TABLE 3

| | YI (1 h at 220° C. under air) ASTM YI |
|---|---|
| | (E313-96) (D65) in SCI (melt state test) |
| 8 (comparative) | 91 |
| 9 | 76 |

It has been observed that the yellowness index value is lower for a powder containing the metal oxide (ex. 9) compared to a powder without the metal oxide (ex. 8). Thus, the use of the metal oxide ZnO in a polyamide powder containing a flame retardant made it possible to improve the color stability of the printed part.

1. A polymer powder suitable for 3D printing by sintering, comprising:
(a) a semicrystalline thermoplastic polymer,
(b) one or more antioxidants and
(c) a metal oxide, a metal hydroxide, and/or a hydrotalcite, the metal oxide, the metal hydroxide and the hydrotalcite being derived from one or more alkaline-earth metals, or from one or more post-transition metals.

2. The powder as claimed in claim 1, wherein component (c) is derived from one or more metals chosen from aluminum, gallium, indium, magnesium, calcium, zinc and/or tin.

3. The powder as claimed in claim 1, wherein component (c) is chosen from ZnO and Al₂O₃.

4. The powder as claimed in claim 1, wherein component (b) is chosen from one or more phenolic antioxidants, one or more phosphite/phosphonite antioxidants, one or more thioethers, and/or mixtures thereof.

5. The powder as claimed in claim 4, wherein component (b) is chosen from one or more phenolic antioxidants, one or more thioethers, and/or mixtures thereof.

6. The powder as claimed in claim 1, wherein the semicrystalline thermoplastic polymer is chosen from: polyolefin, polyamide, polyester, polyarylether ketone, polyphenylene sulfide, polyacetal, polyimide, polyvinylidene fluoride, and/or mixtures thereof.

7. The powder as claimed in claim 6, wherein the polyamide is chosen from a homopolyamide, a copolyamide, a copolymer having polyamide blocks and polyether blocks (PEBA), and/or mixtures thereof.

8. The powder as claimed in claim 1, comprising fillers or reinforcements (d) and/or one or more additional additives (e).

9. The powder as claimed in claim 1, comprising:
(a) 36% to 99.9% by weight of a thermoplastic polymer;
(b) 0.1% to 2% by weight of one or more antioxidants;
(c) 0.05% to 5% by weight of a metal oxide, a metal hydroxide, and/or a hydrotalcite;
(d) 0% to 50% by weight of fillers or reinforcements; and
(e) 0% to 30% by weight of additional additives,
the respective proportions of the components (a), (b), (c), (d) and (e) adding up to 100%.

10. The powder as claimed in claim 1, having a diameter Dv50 of 40 to 150 μm.

11. A process for preparing a powder as claimed in claim 1, comprising one or more of the following steps:
(i) synthesizing a thermoplastic polymer (a),
(ii) grinding the thermoplastic polymer (a) into a powder with a diameter Dv50 of 40 to 150 μm,
(iii) introducing one or more antioxidants (b), and a metal oxide, a metal hydroxide and/or a hydrotalcite (c), and, where appropriate, one or more components (d) to (e), before or after step (ii).

12. A process for preparing a powder as claimed in claim 1, comprising the steps of:
(i) prepolymerizing the monomer(s) of the thermoplastic polymer (a);
(ii) grinding into a powder;
(iii) subjecting the resulting prepolymer powder to solid-phase polycondensation to obtain a polymer powder;
(iv) introducing one or more antioxidants (b), a metal oxide, a metal hydroxide and/or a hydrotalcite (c), and where appropriate one or more components (d) to (e), to the prepolymer powder by melt blending or dry blending, between steps (i) and (ii), and/or (ii) and (iii), and/or subsequently by dry blending.

13. A method of using a metal oxide, a metal hydroxide, and/or a hydrotalcite derived from one or more alkaline-earth metals, or from one or more post-transition metals, in a polymer powder suitable for 3D printing by sintering, for improving the thermal stability of said powder.

14. A method of using a metal oxide, a metal hydroxide, and/or a hydrotalcite derived from one or more alkaline-earth metals, or from one or more post-transition metals, in a polymer powder suitable for 3D printing by sintering, for improving the mechanical property of the printed parts manufactured from said powder.

15. The use as claimed in claim 13, wherein the powder comprises one or more antioxidants, preferably chosen from one or more phenolic antioxidants, one or more phosphite/phosphonite antioxidants, one or more thioethers, and/or mixtures thereof.

16. The use as claimed in claim 13, wherein the metal oxide is chosen from ZnO and Al₂O₃.

17. A 3D printing process, using a powder as claimed in claim 1, or a powder composition comprising a non-agglomerated portion of said powder recovered after one or more builds within the same printing process or a different printing process.

18. A manufactured article obtained by the 3D printing process of claim 17.
